(19) United States
(12) Patent Application Publication
(10) Pub. No.: US 2025/0197096 A1
(43) Pub. Date: Jun. 19, 2025

(54) AEROSOL-GENERATING SYSTEM WITH HUMIDITY INDICATOR

(71) Applicant: Philip Morris Products S.A., Neuchatel (CH)

(72) Inventors: Yiu Chi CHEUNG, Hong Kong (CN); Shing Tak Augustus YEUNG, Hong Kong (CN)

(73) Assignee: Philip Morris Products S.A., Neuchatel (CH)

(21) Appl. No.: 18/849,354

(22) PCT Filed: Mar. 31, 2023
(86) PCT No.: PCT/EP2023/058550

§ 371 Date: Sep. 20, 2024

(30) Foreign Application Priority Data
Mar. 31, 2022 (EP) 22165860.2

(51) Int. Cl. B65D 85/10; A24F 40/20; A24F 40/46; A24F 40/65; B65D 51/24; G01N 31/22

(52) U.S. Cl. CPC B65D 85/1081; A24F 40/20; A24F 40/46; A24F 40/65; B65D 51/245; B65D 85/1045; B65D 2203/06; B65D 2203/12; G01N 31/222

(57) ABSTRACT

An aerosol-generating system is provided, including at least two aerosol-generating articles, a pack for the articles, and an aerosol-generating device, the pack including: an inner liner arranged to seal the articles before usage; a humidity indicator arranged inside of the inner liner; and an outer housing, an inner liner being arranged within the outer housing, and the device including: a controller, and a communication element to receive humidity information of an article and including a humidity detector including a camera pointed toward the humidity indicator of the pack, the device being configured to be operated in two different operating regimes, and the controller to control operation of the device in the operating regimes based upon the received humidity information. An aerosol-generating article, and a kit including at least two aerosol-generating articles, are also provided.

The present invention relates to an aerosol-generating system comprising at least two aerosol-generating articles, a pack for the aerosol-generating articles and an aerosol-generating device. The invention further relates to an aerosol-generating article. The invention further relates to a pack. The invention further relates to an aerosol-generating device. The invention further relates to a kit.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. Multiple aerosol-generating articles are stored in a pack before usage. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device. The consistency of the generated aerosol depends upon the humidity of the aerosol-forming substrate of the aerosol-generating article.

It would be desirable to have one or more of a pack for aerosol-generating articles, an aerosol-generating article, an aerosol-generating device and an aerosol-generating system improving the consistency of the generated aerosol. It would be desirable to have one or more of a pack for aerosol-generating articles, an aerosol-generating article, an aerosol-generating device and an aerosol-generating system improving the consistency of the generated aerosol under varying humidity conditions.

According to an embodiment of the invention there is provided an aerosol-generating system comprising at least two aerosol-generating articles, a pack for the aerosol-generating articles and an aerosol-generating device. The pack may be configured for storing at least two aerosol-generating articles. The pack may comprise an inner liner. The inner liner may be a discrete separate element from a blank forming an outer housing of the pack. The inner liner may be arranged to seal the aerosol-generating articles before usage. The inner liner may seal the aerosol-generating articles even after the first opening of the pack. The inner liner may seal the aerosol-generating articles when an outer pack wrapper is removed. The inner bundle formed by the liner may create a sealed protection environment to continue protecting the aerosol-generating articles from the ambient environment even after removal of the outer pack wrapper and even after opening of the outer housing. The pack may further comprise a humidity indicator. The humidity indicator may be arranged inside of the inner liner.

According to an embodiment of the invention there is provided an aerosol-generating system comprising at least two aerosol-generating articles, a pack for the aerosol-generating articles and an aerosol-generating device. The pack comprises an inner liner. The inner liner is arranged to seal the aerosol-generating articles before usage. The pack further comprises a humidity indicator. The humidity indicator is arranged inside of the inner liner.

The humidity indicator may enable to gather humidity information of the aerosol-generating articles. The humidity information may be used to optimize the heating of the aerosol-generating articles by the aerosol-generating device.

Based on the relative humidity level of aerosol-generating articles, the operating heat profile from the heating element of the aerosol-generating device may be adapted accordingly to optimize the use conditions.

The pack may comprise a rigid hinge-lid container having a box and a lid connected to the box about a hinge line extending across the rear wall of the container. The rigid hinge-lid container may be the outer housing. The hinge-lid container may be constructed from a one-piece laminar cardboard blank. In use, the lid may be pivoted about the hinge line to open the container and so gain access to the aerosol-generating articles housed in the box.

The aerosol-generating articles housed in the box may be wrapped in the inner liner. The inner liner may be made of metallized paper, metal foil or other flexible sheet material with moisture barrier property.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

The aerosol-generating article may be substantially cylindrical in shape. The aerosol-generating article may be substantially elongate. The aerosol-generating article may have a length and a circumference substantially perpendicular to the length. The aerosol-generating article may be substantially rod shaped. The aerosol-forming substrate may be substantially cylindrical in shape. The aerosol-forming substrate may be substantially elongate. The aerosol-forming substrate may also have a length and a circumference substantially perpendicular to the length. The aerosol-forming substrate may be substantially rod shaped.

The aerosol-generating substrate may comprise an aerosol-former. The aerosol-generating substrate preferably comprises homogenised tobacco material, an aerosol-former and water. Providing homogenised tobacco material may improve aerosol generation, the nicotine content and the flavour profile of the aerosol generated during heating of the aerosol-generating article. Specifically, the process of making homogenised tobacco involves grinding tobacco leaf, which more effectively enables the release of nicotine and flavours upon heating.

The aerosol-generating substrate preferably comprises: homogenised tobacco material between about 55 percent and about 75 percent by weight; aerosol-former between about 15 percent and about 25 percent by weight; and water between about 10 percent and about 20 percent by weight.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The electric circuitry may be configured to regulate a supply of power to the heating element based upon humidity information of the humidity indicator. The electric circuitry may be configured to control supply of different levels of power to the hearing element corresponding to different humidity levels of the aerosol-generating articles according to humidity information of the humidity indicator. The electric circuitry may be configured to control supply of power to the hearing element according to different hearing regimes, wherein the different hearing regimes correspond to different humidity levels of the aerosol-generating articles according to humidity information of the humidity indicator.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The heating chamber of the aerosol-generating device may be configured as a cavity. The cavity may be configured to receive an aerosol-generating article comprising aerosol-forming substrate. The cavity of the aerosol-generating device may have an open end into which the aerosol-generating article is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity may have a hollow cylindrical shape. The cavity may have a shape corresponding to the shape of the aerosol-generating article to be received in the cavity. The cavity may have a circular cross-section. The cavity may have an elliptical or rectangular cross-section. The cavity may have an inner diameter corresponding to the outer diameter of the aerosol-generating article.

An airflow channel may run through the cavity. Ambient air may be drawn into the aerosol-generating device, into the cavity and towards the user through the airflow channel. Downstream of the cavity, a mouthpiece may be arranged or a user may directly draw on the aerosol-generating article. The airflow channel may extend through the mouthpiece.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

As described, in any of the aspects of the disclosure, the heating element may be part of the aerosol-generating device. The aerosol-generating device may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni—Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation.

An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

The pack may further comprise an outer housing. The outer housing may be the container described herein. The inner liner may be arranged within the outer housing.

The outer housing may comprise or may be made of cardboard material.

The pack may consist of the outer housing, the inner liner and the humidity indicator.

The inner liner may be made of metallized paper, metal foil or other flexible sheet material with moisture barrier property. The inner liner may be fluid-impermeable. The inner liner may hermetically seal the aerosol-generating articles before usage, even after the first opening of the pack, particularly after opening of the outer container of the pack.

The inner liner may be configured to be opened before a first user experience.

The humidity indicator may be attached to the inner liner. The humidity indicator may be attached to an inner surface of the inner liner. In other words, the humidity indicator may be placed inside of the inner liner.

The humidity indicator may be arranged inside of the inner liner. The humidity indicator may be arranged adjacent an inner surface of the inner liner. The humidity indicator may be arranged in contact with the inner liner.

The humidity indicator may be arranged at a top wall of the inner liner. The humidity indicator may be arranged at an inner surface of the top wall of the inner liner.

The inner liner may comprise a top wall, a bottom wall, a front wall, a back wall and two opposing sidewalls. The top wall may be arranged at a proximal end of the inner liner. The proximal end of the inner liner may face a top of the pack.

The humidity indicator may be arranged such that the humidity indicator becomes visible to a user when the inner liner is opened.

The humidity indicator may be configured as a colour humidity indicator. The humidity indicator may be configured to change colour, if the humidity the humidity indicator is subjected to changes. The humidity indicator may be configured to indicate the humidity the humidity indicator is subjected to via the colour of the humidity indicator.

The pack may further comprise a humidity comparative table. The pack may further comprise a humidity colour comparative table. The humidity colour comparative table may comprise at least two QR codes associated with at least two colours indicating at least two different humidity levels.

The humidity comparative table may indicate different humidity levels. In case the humidity comparative table is configured as a humidity colour comparative table, the humidity colour comparative table may comprise different colours. The different colours of the humidity colour comparative table may indicate different humidity levels.

The humidity comparative table may comprise multiple different indication elements indicative of multiple different humidity levels. In case the humidity comparative table is configured as a humidity colour comparative table, the different indication elements may be configured as different colours indicative of different humidity levels.

Each different indication element may be associated with a readable element such as a QR code to enable reading of the particular indication element. During use, a user may optically identify which indication element of the humidity comparative table is appropriate for the indicated humidity of the humidity indicator. Exemplarily, a user may identify an indication element of the humidity comparative table with a colour that matches closest the colour of the colour humidity indicator. Subsequently, the user may use the aerosol-generating device or an external device such as a smartphone to read the identified indication element of the humidity comparative table. In case the aerosol-generating device is used to read the identified indication element, a controller of the aerosol-generating device may then choose a heating profile for the aerosol-forming article that is optimized for the humidity of the aerosol-generating article. The aerosol-generating device may use a humidity detector for reading the identified indication element as described in more detail below. In case an external device is used to read the identified indication element, a heating profile for the aerosol-forming article that is optimized for the humidity of the aerosol-generating article may be chosen by the external device or by a user via the external device. The heating profile may then be transferred to the aerosol-generating device from the external device, for example via a wireless transmission, and subsequently employed by the aerosol-generating device.

The humidity comparative table may be arranged next to the humidity indicator. This may make it easier to compare the information from the humidity indicator with the humidity comparative table. In case the humidity indicator is configured as a colour humidity indicator and the humidity comparative table is configured as a humidity colour comparative table, the colour of the colour humidity indicator may be compared with the closest colour of the humidity colour comparative table to estimate the humidity.

The humidity indicator may be arranged to indicate the humidity of the aerosol-generating articles. The arrangement of the humidity indicator in the inner liner means that the aerosol-generating articles and the humidity indicator are subjected to the same humidity level and thus that the humidity indicated by the humidity indicator is indicative of the humidity of the aerosol-generating articles.

The humidity indicator may comprise a blotting paper impregnated with one of cobaltous, chloride copper(II) chloride and copper bromide.

The invention further relates to an aerosol-generating article comprising a humidity indicator. The humidity indicator may be configured as a colour humidity indicator. The humidity indicator may be arranged on the periphery of the aerosol-generating article.

The invention further relates to an aerosol-generating article comprising a humidity indicator. The humidity indicator is configured as a colour humidity indicator. The humidity indicator is arranged on the periphery of the aerosol-generating article.

The invention further relates to a pack for aerosol-generating articles. The pack may comprise an inner liner. The inner liner may be arranged to seal aerosol-generating articles before usage, even after the first opening of the pack. The pack may further comprise a humidity indicator. The humidity indicator may be arranged inside of the inner liner.

The invention further relates to a pack for aerosol-generating articles. The pack comprises an inner liner. The inner liner is arranged to seal aerosol-generating articles before usage, even after the first opening of the pack. The pack further comprises a humidity indicator. The humidity indicator is arranged inside of the inner liner.

The invention further relates to a kit comprising at least two aerosol-generating articles as described herein and a pack as described herein.

The invention further relates to an aerosol-generating device. The aerosol-generating device may comprise a communication element configured to receive humidity information. The aerosol-generating device may further comprise a controller. The aerosol-generating device may be configured to be operated in at least two different operating regimes. The controller may be configured to control operation of the aerosol-generating device in the different operating regimes based upon the received humidity information.

The invention further relates to an aerosol-generating device. The aerosol-generating device comprises a communication element configured to receive humidity information. The aerosol-generating device further comprises a controller. The aerosol-generating device is configured to be operated in at least two different operating regimes. The controller is configured to control operation of the aerosol-generating device in the different operating regimes based upon the received humidity information.

The communication element may be a user interface. A user may manually input the humidity information indicated by the humidity indicator of the pack into the user interface. The controller of the aerosol-generating device may, using the humidity information, choose an optimized operating regime for heating the aerosol-forming substrate of the aerosol-generating article.

An operating regime of the aerosol-generating device may correspond to a heating regime of a hearing element of the aerosol-generating device.

The aerosol-generating device may further comprise a cavity for receiving aerosol-forming substrate. The aerosol-generating device may further comprise a heating element that is arranged one or both of in the cavity or at least partly surrounding the cavity. The heating element may be configured to heat the aerosol-forming substrate, when the aerosol-forming substrate is received in the cavity. The different operating regimes may be different heating regimes of the heating element.

The communication element may comprise one or more of:
an element for receiving the humidity information from an external device,
a humidity detector, preferably wherein the humidity detector comprises a camera, more preferably wherein the humidity detector is configured to detect the humidity information by reading the information of a humidity colour comparative table, and
a communication interface, wherein the communication interface is configured to enable a user to manually input the humidity information.

In case the communication element comprises an element for receiving the humidity information from an external device, the humidity information may be transmitted via Wi-Fi, Bluetooth or other known means. The element may be a corresponding receiver. The element may be part of electric circuitry of the aerosol-generating device. The external device may be a smartphone, tablet, smartwatch or other known external device. Exemplarity, a user may use his or her smartphone to read the humidity information from the humidity indicator and the smartphone may transmit this information to the aerosol-generating device such that an optimized operating regime is chosen by the aerosol-generating device for hearing the aerosol-forming substrate of the aerosol-generating article, if an aerosol-generating article from the pack is received in the aerosol-generating device.

In case the communication element comprises a humidity detector, the aerosol-generating device itself may be used to read the humidity information of the humidity indicator. For example, the humidity detector may comprise a camera as a humidity detector. A user may use the camera of the aerosol-generating device such that the camera is pointed toward the humidity indicator of the pack. The camera and the controller of the aerosol-generating device may then read the humidity information of the humidity indicator and adjust the operating regime of the aerosol-generating device accordingly. For example, the humidity detector may be configured to detect the humidity information by reading the information of a humidity colour comparative table.

In case the communication element comprises a communication interface, a user may manually input the humidity information into the communication interface of the aerosol-generating device.

The invention further relates to an aerosol-generating system comprising a pack as described herein and an aerosol-generating device as described herein.

The invention further relates to an aerosol-generating system comprising at least two aerosol-generating articles as described herein and an aerosol-generating device as described herein.

The invention further relates to an aerosol-generating system comprising an aerosol-generating device as described herein and an external device. The communication element of the aerosol-generating device may be configured for receiving the humidity information from the external device.

The invention further relates to an aerosol-generating system comprising an aerosol-generating device as described herein and an external device. The communication element of the aerosol-generating device is configured for receiving the humidity information from the external device.

Below, there is provided a non-exhaustive list of non-limiting examples. Any one or more of the features of these examples may be combined with any one or more features of another example, embodiment, or aspect described herein.

Example ex1. An aerosol-generating system comprising at least two aerosol-generating articles, a pack for the aerosol-generating articles and an aerosol-generating device, wherein the pack comprises:
an inner liner, wherein the inner liner is arranged to seal the aerosol-generating articles before usage, even after the first opening of the pack, and
a humidity indicator, wherein the humidity indicator is arranged inside of the inner liner.

Example ex2. The system according to example ex1, wherein the pack further comprises an outer housing, and wherein the inner liner is arranged within the outer housing.

Example ex3. The system according to any of the preceding examples, wherein the inner liner is fluid-impermeable, preferable wherein the inner liner hermetically seals the aerosol-generating articles before usage, even after the first opening of the pack.

Example ex4. The system according to any of the preceding examples, wherein the humidity indicator is configured as a colour humidity indicator.

Example ex5. The system according to any of the preceding examples, wherein the pack further comprises a humidity comparative table, preferably wherein the pack further comprises a humidity colour comparative table, more preferably wherein the humidity colour comparative table comprises at least two QR codes associated with at least two colours indicating at least two different humidity levels.

Example ex6. The system according to any of the preceding examples, wherein the humidity indicator is arranged nestled between the aerosol-generating articles.

Example ex7. The system according to any of the preceding examples, wherein the humidity indicator is provided on a card, preferably wherein the card is not structurally connected with the pack and with the aerosol-generating articles.

Example ex8. The system according to any of the preceding examples, wherein the humidity indicator comprises multiple individual humidity indicators, and wherein each aerosol-generating article is provided with a humidity indicator.

Example ex9. The system according to any of the preceding examples, wherein the humidity indicator is a reversible humidity indicator or a non-reversible humidity indicator.

Example ex10. The system according to any of the preceding examples, wherein the humidity indicator comprises a blotting paper impregnated with one of cobaltous, chloride copper(II) chloride and copper bromide.

Example ex11. An aerosol-generating article comprising a humidity indicator, wherein the humidity indicator is configured as a colour humidity indicator, and wherein the humidity indicator is arranged on the periphery of the aerosol-generating article.

Example ex12. The aerosol-generating article according to example ex11, wherein the humidity indicator is a reversible humidity indicator or a non-reversible humidity indicator.

Example ex13. The aerosol-generating article according to any of examples ex11 or ex12, wherein the humidity indicator comprises a blotting paper impregnated with one of cobaltous, chloride copper(II) chloride and copper bromide.

Example ex14. A pack for aerosol-generating articles, the pack comprising:
an inner liner, wherein the inner liner is arranged to seal aerosol-generating articles before usage, even after the first opening of the pack, and
a humidity indicator, wherein the humidity indicator is arranged inside of the inner liner.

Example ex15. A kit comprising at least two aerosol-generating articles according to any of examples ex11 to 13 and a pack according to example ex14.

Example ex16. An aerosol-generating device comprising:
a communication element configured to receive humidity information, and
a controller,
wherein the aerosol-generating device is configured to be operated in at least two different operating regimes, and wherein the controller is configured to control operation of the aerosol-generating device in the different operating regimes based upon the received humidity information.

Example ex17. The aerosol-generating device according to example ex16, wherein the aerosol-generating device further comprises a cavity for receiving aerosol-forming substrate, wherein the aerosol-generating device further comprises a heating element that is arranged one or both of in the cavity or at least partly surrounding the cavity, wherein the heating element is configured to heat the aerosol-forming substrate, when the aerosol-forming substrate is received in the cavity, and wherein the different operating regimes are different heating regimes of the heating element.

Example ex18. The aerosol-generating device according to example ex16 or 17, wherein the cavity is configured for receiving an aerosol-generating article comprising the aerosol-forming substrate.

Example ex19. The aerosol-generating device according to any of examples ex16 to ex18, wherein the communication element is configured to receive humidity information of one or both of the aerosol-forming substrate and the aerosol-generating article.

Example ex20. The aerosol-generating device according to any of examples ex16 to ex19, wherein the communication element comprises one or more of:
an element for receiving the humidity information from an external device,
a humidity detector, preferably wherein the humidity detector comprises a camera, more preferably wherein the humidity detector is configured to detect the humidity information by reading the information of a humidity colour comparative table,
a communication interface, wherein the communication interface is configured to enable a user to manually input the humidity information.

Example ex21. An aerosol-generating system comprising a pack according to example ex14 and an aerosol-generating device according to any of examples ex16 to ex20.

Example ex22. An aerosol-generating system comprising at least two aerosol-generating articles according to any of example ex11 to ex13 and an aerosol-generating device according to any of examples ex16 to ex20.

Example ex23. An aerosol-generating system comprising an aerosol-generating device according to any of examples ex16 to ex20 and an external device, wherein the communication element of the aerosol-generating device is configured for receiving the humidity information from the external device.

Features described in relation to one embodiment may equally be applied to other embodiments of the invention.

The invention will be further described, by way of example only, with reference to the accompanying drawings in which:

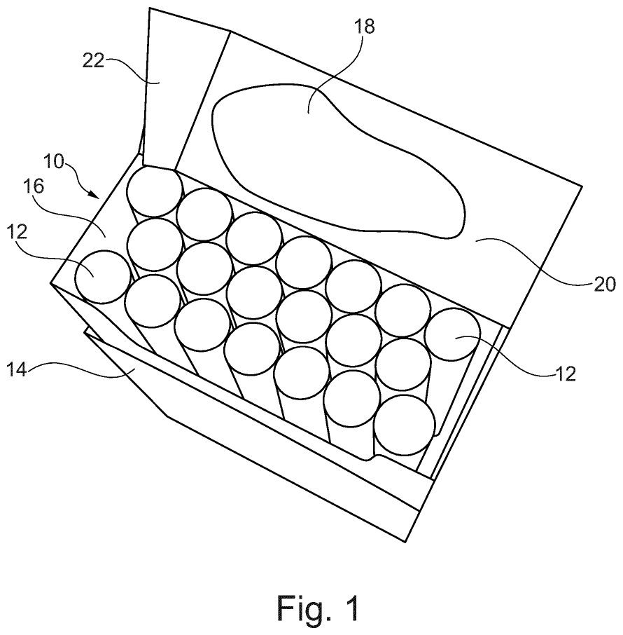

FIG. 1 shows a pack for aerosol-generating articles;

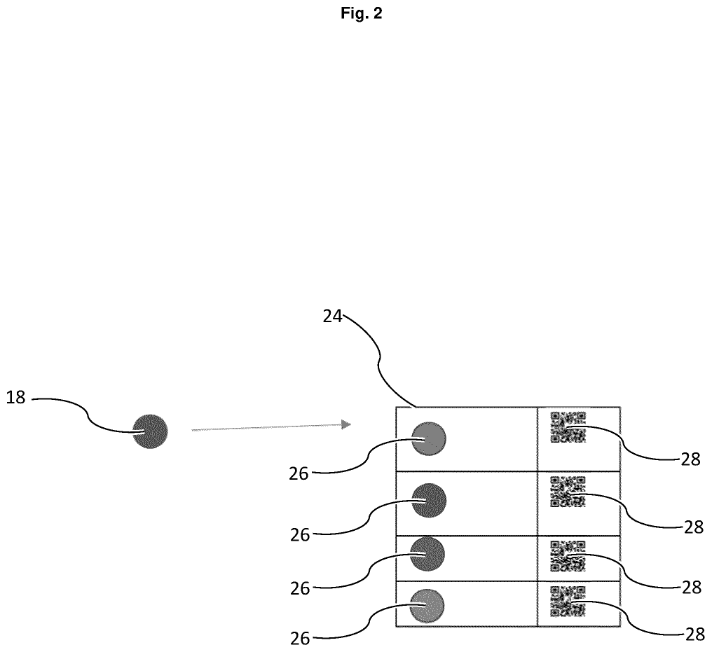

FIG. 2 shows a moisture indicator and a comparative table to be used in the pack; and

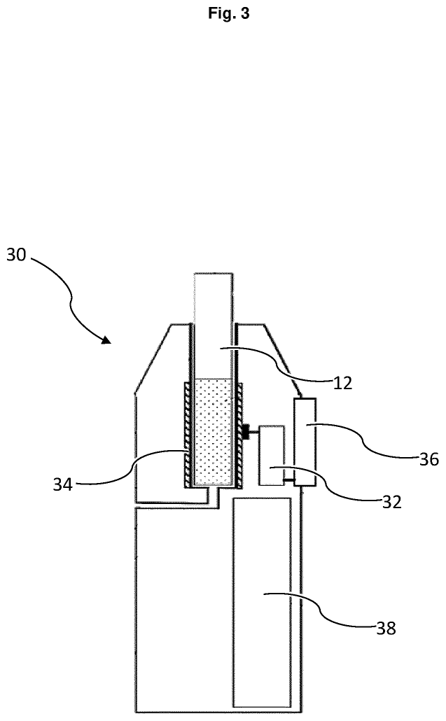

FIG. 3 shows an aerosol-generating device.

FIG. 1 shows a pack 10 for aerosol-generating articles 12. The pack 10 comprises an outer housing 14 and an inner liner 16 arranged within the outer housing 14. The aerosol-generating articles 12 are wrapped by the inner liner 16.

Before a first use, the inner liner 16 seals the aerosol-generating articles 12 from the ambient environment. Before a first use, a user may open the inner liner 16 so as to access the aerosol-generating articles 12. The quality of an aerosol created by an aerosol-generating device (not shown) in which the aerosol-generating articles 12 are used depends upon the humidity of the aerosol-generating articles 12. In order to determine the humidity of the aerosol-generating article and to subsequently control the operating regime of the aerosol-generating device optimally, the pack 10 further comprises a humidity indicator 18.

The humidity indicator 18 is arranged adjacent and inside of a top wall 20 of the inner liner 16. In this way, the humidity indicator 18 is visible to a user when a lid 22 of the outer housing 14 is opened and the inner liner 16 is opened as well. Preferably, the inner liner 16 is automatically opened, when the lid 22 of the outer housing 14 is opened. Opening of the lid 22 may automatically open the inner liner 16 and closing of the lid 22 may automatically close the inner liner 16 as described in the pack of WO2008142540A1, see the respective lid 7 and an inner package 3 having a cover flap 5 connected with the lid 7.

The humidity indicator 18 is configured as a colour humidity indicator 18. The humidity the humidity indicator 18 is subjected to is indicated by the colour of the humidity indicator 18. Different humidity levels can be indicated by different colours. Due to the proximity of the humidity indicator 18 to the aerosol-generating articles 12 and due to the fact that the aerosol-generating articles 12 as well as the humidity indicator 18 are arranged inside of the inner liner 16, the humidity indicated by the humidity indicator 18 closely reflects the humidity of the aerosol-generating articles 12.

As an alternative to arranging the humidity indicator 18 inside of the top wall 20 of the inner liner 16, the humidity indicator 18 may be arranged between the aerosol-generating articles 12. The humidity indicator 18 is in this case arranged on a cart which can be put between the aerosol-generating articles 12. When a user may want to retrieve the humidity information of the humidity indicator 18, the user can remove the card from between the aerosol-generating articles 12 and retrieve the humidity information of the humidity indicator 18.

The humidity indicator 18 may be accompanied by a comparative table 24 as shown in FIG. 2. The humidity indicator 18 shown in FIG. 2 shows a colour indicative of a specific humidity of the aerosol-generating articles 12. The comparative table 24 shown to the right of the humidity indicator 18 in FIG. 2 comprises a first column in which different colours 26 are depicted. The user may choose the colour 26 from the comparative table 24 that is closest to the colour of the humidity indicator 18.

A second column of the comparative table 24 may show the humidity level associated with the respective colour 26. Alternatively, as shown in FIG. 2, the second column of the comparative table 24 may comprise QR codes 28. These QR codes 28 carry the humidity level information associated with the respective colour 26 and can be read by a humidity detector of the aerosol-generating device or by an external device.

In other words, a user can manually read the humidity level of the aerosol-generating articles 12 by comparing the colour of the humidity indicator 18 with the closest colour 26 of the comparative table 24. Alternatively, the respective humidity information can be read by the aerosol-generating device or by an external device by scanning the QR code 28 next to the closest colour 26 of the comparative table 24 in comparison with the colour of the humidity indicator 18.

For reading the QR code 28, the aerosol-generating device comprises the humidity detector. The humidity detector comprises a camera. The aerosol-generating device can read the humidity information, if the user activates the humidity detector and scans the respective QR code 28 with the camera of the humidity detector. The aerosol-generating device will in this embodiment further comprise a controller which is configured to control the operating regime of the aerosol-generating device depending upon the read humidity information of the humidity indicator 18. The aerosol generated by the aerosol-generating device can be optimized by using the most optimal operating regime of the aerosol-generating device depending upon the humidity of the aerosol-generating articles 12.

The same functionality of the aerosol-generating device can be facilitated if the user manually reads the humidity information from the humidity indicator 18 by comparing the colour of the humidity indicator 18 with the respective closest colour 26 of the comparative table 24 and reading the corresponding humidity level. A user can manually input this information into the aerosol-generating device. In this case, the aerosol-generating device comprises a user interface for inputting the humidity information. The controller of the aerosol-generating device can then choose an optimized operating regime for operating the aerosol-generating device.

Similarly, if the user reads the humidity information by scanning a respective QR code 28 with an external device such as a smartphone, this information may be used by the aerosol-generating device to choose an optimal operating regime for generating an aerosol. Alternatively, the respective QR code may directly carry the information of the optimal operating regime. For example, the external device may transfer the respective humidity information or the optimal operating regime information to the aerosol-generating device via Wi-Fi or Bluetooth.

FIG. 3 shows an aerosol-generating device 30 in which aerosol-generating articles 12 as described herein can be heated with an optimized heating profile adapted to the humidity level of the aerosol-generating article 12.

The aerosol-generating device 30 comprises a controller 32 for controlling the heating profile of a heating element 34. The controller will choose a heating profile that is optimized for the specific humidity of the aerosol-generating article 12. Alternatively, instead of the controller choosing an optimized heating profile, the information of a suitable heating profile may be transferred to the controller via a user interface 36 or wirelessly via an external device such as a smartphone. A user interface 36 may for example be a touch display.

FIG. 3 further shows a battery 38 for powering the heating element 34 as well as the controller 32 and, if present, the user interface 36.

1.-14. (canceled)

15. An aerosol-generating system comprising at least two aerosol-generating articles, a pack for the at least two aerosol-generating articles, and an aerosol-generating device,
wherein the pack comprises:
an inner liner arranged to seal the at least two aerosol-generating articles before usage,
a humidity indicator arranged inside of the inner liner, and
an outer housing, wherein the inner liner is arranged within the outer housing, and
wherein the aerosol-generating device comprises:
a controller, and
a communication element configured to receive humidity information of an aerosol-generating article of the at least two aerosol-generating articles, the communication element comprising a humidity detector, wherein the humidity detector comprises a camera pointed toward the humidity indicator of the pack,
wherein the aerosol-generating device is configured to be operated in at least two different operating regimes, and
wherein the controller is configured to control operation of the aerosol-generating device in the at least two different operating regimes based upon the received humidity information.

16. The aerosol-generating system according to claim 15, wherein the inner liner is fluid-impermeable.

17. The aerosol-generating system according to claim 15, wherein the inner liner hermetically seals the at least two aerosol-generating articles before usage.

18. The aerosol-generating system according to claim 15, wherein the humidity indicator is configured as a colour humidity indicator.

19. The aerosol-generating system according to claim 15, wherein the pack further comprises a humidity comparative table.

20. The aerosol-generating system according to claim 15, wherein the pack further comprises a humidity colour comparative table.

21. The aerosol-generating system according to claim 20, wherein the humidity colour comparative table comprises at least two QR codes associated with at least two colours indicating at least two different humidity levels.

22. The aerosol-generating system according to claim 15, wherein the humidity indicator comprises a blotting paper impregnated with one of cobaltous, chloride copper(II) chloride, and copper bromide.

23. An aerosol-generating article comprising a humidity indicator, wherein the humidity indicator is configured as a colour humidity indicator, and wherein the humidity indicator is arranged on a periphery of the aerosol-generating article.

24. A kit comprising at least two aerosol-generating articles according to claim 23, and a pack, the pack comprising:
an inner liner arranged to seal aerosol-generating articles before usage;
a humidity indicator arranged inside of the inner liner; and
an outer housing, wherein the inner liner is arranged within the outer housing.

25. The aerosol-generating system according to claim 15,
wherein the aerosol-generating device further comprises
a cavity configured to receive an aerosol-forming substrate, and
a heating element that is arranged one or both of in the cavity or at least partly surrounding the cavity,
wherein the heating element is configured to heat the aerosol-forming substrate when the aerosol-forming substrate is received in the cavity, and
wherein the at least two different operating regimes are different heating regimes of the heating element.

26. The aerosol-generating system according to claim 15, wherein the communication element further comprises one or more of:
an element configured to receive the humidity information from an external device,
the humidity detector configured to detect the humidity information by reading information of a humidity colour comparative table, and
a communication interface configured to enable a user to manually input the humidity information.

27. The aerosol-generating system according to claim 15,
further comprising an external device,
wherein the communication element of the aerosol-generating device is further configured to receive the humidity information of an aerosol-generating article of the at least two aerosol-generating articles from the external device.
